(19) United States
(12) Patent Application Publication
(10) Pub. No.: US 2014/0093617 A1
(43) Pub. Date: Apr. 3, 2014

(54) HIGH PROTEIN, LOW FAT CRISP SNACK PRODUCT

(71) Applicant: CARTON BROTHERS, Co. Meath (IE)

(72) Inventors: Mark Hynes, Co. Donegal (IE); Herbert Brendan Mitchell, Co. Cork (IE)

(73) Assignee: CARTON BROTHERS, Co. Meath (IE)

(21) Appl. No.: 14/111,050

(22) PCT Filed: Apr. 13, 2012
(86) PCT No.: PCT/EP2012/056770

§ 371 Date: Dec. 11, 2013

(30) Foreign Application Priority Data
Apr. 14, 2011 (GB) 1106299.9

(51) Int. Cl. A23L 1/305

(52) U.S. Cl. CPC A23L 1/3056
USPC 426/89; 426/242

(57) ABSTRACT

The present invention relates to high protein low fat snack products including crisps and to methods of producing them. The products are dried and expanded products. In one embodiment the product is a heat-expanded and dried crisp snack product based on milk proteins. Other products are in effect synthetic cheese snack products.

### FIELD OF THE INVENTION

The present invention relates to high protein low fat snack products including crisps and to methods of producing them. The products are dried and expanded products. In one embodiment the product is a heat-expanded and dried crisp snack product based on milk proteins. Other products are in effect synthetic cheese snack products.

### BACKGROUND TO THE INVENTION

In recent years it has become the trend for consumers to choose foods that are convenient and tasty and to consume snack food products which represent a “treat” or fit in with a busy lifestyle. Such snack foods tend to be nutritionally unbalanced and they can be high in fat and carbohydrates and low in protein. Snack products that are high in fat and calories contribute to obesity and other chronic diseases such as coronary heart disease etc. The well-informed consumer is therefore developing a need for lower fat but higher protein type snack products.

High protein snack products are also convenient for athletes and keep-fit enthusiasts, who are trying to follow a healthier lifestyle by following a high protein/low fat diet. With such a diet, it is difficult to find a snack food product that is not high in fat.

Heat-expanded and dried snack food products are known, as are heat-expanded crispy, puffed and flat crisp (or chips as they are referred to in the US) snack food products. These are often based on starches or on milk proteins. Typically, such products have a very high fat content and are, therefore, unhealthy. Products based on milk proteins generally have to be extruded in order to produce a puffed product, because a heat-expanded, crispy synthetic cheese product is difficult to achieve. Popcorn can easily be puffed by heating because of its high starch content, but products with higher protein contents are more difficult to puff and dry.

Traditional Twin Screw Technology

Crisps, refer to many different types of snack products in the UK and Ireland, some made from potato, but they may also be made from corn, maize and tapioca. The term “Crisps” is also used in North America to refer to potato snacks made from reconstituted dried potato flakes and other fillers, such as “Baked Lay's™” and Pringles™, although Pringles are technically “quick-fried” in oil.

Potato chips are a predominant part of the snack food market in developed countries nations. The global potato chip market generated total revenues of US$16.4 billion in 2005. This accounted for 35.5% of the total savoury snacks market in that year (US$46.1 billion).

Another type of potato chip, notably the Pringles and Lay's Stax™ brands, is made by extruding or pressing a dough made from ground potatoes into the desired shape before frying. This makes chips that are very uniform in size and shape, which allows them to be stacked and packaged in rigid tubes. In America, the official term for Pringles is “potato crisps”, but they are rarely referred to as such. Conversely Pringles may be termed “potato chips” in Britain, to distinguish them from traditional “crisps”.

### OBJECT OF THE INVENTION

It is thus an object of the present invention to provide a heat-expanded and dried snack food crisp product based on milk proteins. The product preferably has a crispy texture. A further object is to provide a process for producing a puffed milk protein snack product which can be puffed by microwave.

A further object is to control the shape of the product to produce a more conventional flat, crunchy, high protein crisp, controlling the level of expansion through the coating of the un-expanded product with vegetable oils (including rapeseed oil and sunflower oil etc.) prior to expansion.

A further object is to provide a simple process for producing a crisped synthetic food product which is tasty and attractive to the consumer

A further object is to produce a low fat product.

It would not have been predicted that a milk protein based product comprising about 10-41% protein could be puffed by microwave, since it would not be expected that a microwave would remove enough moisture to allow the product to puff. The residence time in the microwave would have been expected to be too long in order to puff and dry the product without burning or adversely affecting the nutritional composition of the product. In the past, microwaves proved unsuccessful when used for drying pasta due to the tight and dense nature of the structure of pasta and the inefficiencies in the microwave technology used.

### SUMMARY OF THE INVENTION

According to the invention there is provided a method of making an expanded high protein snack product comprising

(A) Mixing together water, protein and emulsifying salts in a pre-heated mixer at about 50 degrees centigrade,

(B) Heating the mixture to about 80 degrees centigrade and adding starch,

(C) Mixing until all free water is absorbed, and (D) adding a preservative,

(E) Chilling the mixture and cutting it into pieces

(F) Expanding the mixture by heating in a microwave at 800-1100 MHz frequency and a power of 10-75 kW,

wherein the cut pieces of step (E) are coated in vegetable oil.

Preferably, the microwave used has magnetron waveguide modulator technology (also known as a mode stirrer or polariser). A circular polarising waveguide modulator with side shielding technologies is suitable.

The invention also provides a snack food product comprising a standard recipe of approximately 18-38% by weight of protein, approximately 5-30% by weight of a starch, approximately 40-65% water. The product may preferably comprise 20 to 30% by weight protein and 7 to 18 5% by weight starch.

The product may further comprise emulsifiers, preservatives and flavourings. The product may further comprise vegetable oils.

The protein may be selected from rennet casein, acid casein and whey milk proteins, soya, rice protein and pea protein or combinations thereof. Flaxseed may also be used as a partial source of protein and fat. The preferred protein source is rennet casein. The starch may be maize derived starch including Hi-Maize 260®, other corn starches, rice starch, flax starch, tapioca or potato starches

The preservatives and flavourings may include sodium chloride, trisodium citrate, disodium phosphate, citric acid and sorbic acid.

The order of addition of ingredients is important, as the protein must be hydrated by the action of the emulsifying salts before the starch is added to the mix. The emulsifying salts may be trisodium citrate and disodium phosphate.

The process may additionally comprise the addition of vegetable oil in step (A). The vegetable oils may be selected from palm oil, olive oil, sunflower oil, rapeseed oil, canola oil or the like.

When the protein is hydrated, the temperature is increased to 80° C. and the starch added. The mixture is then processed until all free water had been absorbed and finally a preservative such as citric acid is added to the mix. The processing time is approximately 20 minutes. The product is then chilled prior to expansion. Preferably the microwave used to expand/dry the product is a 915 MHz+/−100 MHz microwave with a 75-100 kW generator and magnetron.

The residence time (time the product is exposed to microwave power) in the industrial microwave is between 5 and 30 seconds. The residence time is related to the microwave power. Higher power means that less residence time is required. With the power at ˜50 kW, residence time would need to be about 5-10 seconds. At lower levels (˜20 kW), residence time may be 20-30 seconds. In the 1 KW kitchen microwave, a heating time of approximately 90 seconds was required to expand the product and dry to ˜13% moisture content.

The mixture may be cut into bite size pieces prior to microwaving. By this it is meant that the mix is cut into small blocks approximately 1×1×2 centimetres, although it is apparent that other sizes could be used to produce either different bite size pieces or bars of snack resembling a bar of chocolate.

Expansion was initially thought to be driven by the starch, but it is now thought that it is the water which drives the expansion. Under the influence of intense microwave energy, the water in the product rapidly heats to boiling point, rapidly changing from a liquid to a gaseous state. Heated water vapour expands and rapidly escapes from the protein/starch matrix, in turn causing the matrix to expand. This heated water, driven off in the form of steam gives the bubble-like internal structure of the expanded product. When the desired finished product is a flat, more traditional crisp-shaped product, this can be achieved through the addition of vegetable oils to the mix and or surface coating the unexpanded product pieces prior to microwaving.

Cooling will allow automation of the line whilst still permitting expansion and drying in the microwave. Note we have proven that neither effective drying and or expansion will occur unless the product is sufficiently chilled prior to micro waving.

The invention uses exclusively low frequency microwave technology at 800-1100 MHz. The wavelength of the microwave offers up to four times higher product penetration and a more uniform heating pattern than traditional domestic microwaves (2450+/−100 MHz). Surprisingly, high-powered industrial microwaves (power of up to 100 kW) with low frequency highly penetrating microwaves result in a puffed product whilst allowing the product to be commercially dried and cooked with enhanced mouth feel acceptability and enhanced shelf life, due to the lower achievable moisture content (as low as 3.5%). Microwaves have not been used in the past to commercially produce high protein, low fat healthy snacks and crisps. The traditional method of producing such a product is via twin-screw extrusion. It has been surprisingly found that microwave technology will expand such a product and allow water to be removed from the product on a commercially viable scale.

It could not be predicted that a milk protein based product comprising about 18-38% protein could be puffed by a microwave in an industrial commercially viable manner. This is so as it would not be expected that a microwave would remove enough moisture to allow the product to puff and expand. The residence time in the microwave would have been expected to be too long in order to puff and dry the product. In the past, microwaves proved unsuccessful when used for drying and cooking pasta.

None of the leading brand names use low frequency microwave technology as a method to dry and expand their product.

The present inventors have found that Lower frequency microwave energy, because of its longer wavelength, allows for deeper penetration and higher input of microwave energy (power) into a product. Intense Sensible and Latent heat can be injected causing water within the product to rapidly change state from gaseous to liquid in a uniform and intense manner. This results in the product expanding and drying in a uniform, and in an energy efficient manner, without hot and cold spots and without burning. Traditionally, only twin-screw technologies were thought to produce efficient and uniform drying and expansion. From a commercial retail food quality viewpoint uniformity is an essential requirement.

The present invention dries the product in a microwave cooker/dryer, reducing the product moisture from ˜60% to a final 3.5-10%. (Range 2.5%-15% moisture in the final product). Conventional wisdom would indicate that the product could not be produced on a financially viable Industrial scale as too much power would be required to remove sufficient water from the product. The inventors have shown thathigh powered microwave technology using 800-1100 MHz, coupled with a high powered 10-75 KW generator and magnetron (polariser) yielding an 80% conversion rate from electrical power to microwave power, will efficiently remove the desired amounts of moisture and do so in a commercially viable manner. This technology provides the most reliable and cost effective method to produce a puffed product, or a flat crispy product during cooking and drying.

Conventional methods of “channelling” microwave energy will not efficiently remove this level of water, making the process commercially unviable. In essence, microwaves are projected into the heating chamber in a liner fashion, resulting in some parts of the chamber being subjected to more microwave energy than others. Due to the straight line trajectory of the waves the residence time or time that the microwave energy stays in contact with the targeted food product varies and so efficient power usage low, meaning that traditionally, such technology could not be used to commercially dry and expand snack food products. Up scaling was not considered viable and so alternative technologies such as twi-screw extrusion are predominantly used to expand and dry snack foods and crisps.

To improve efficiencies we use waveguide modulator technology or microwave mode stirrers. The microwaves are directed via waveguide modulator technology (mode stirrers), so that the microwaves move in a focused clockwise or anticlockwise fashion. The net result is that instead of hitting the product in a linear fashion, bouncing all around the heating chamber walls and only occasionally striking the product, the circularly polarized microwave energy is focused on the target product, at a directed constant magnitude but continually rotating phase. The product moisture in essence in spun out of the product. This means that the product can be dried more quickly, uniformly and efficiently.

Since the introduction of microwave ovens, it has been recognized that the spatial distribution of the microwave energy in the cavity tends to be non-uniform. This non-uniformity may cause undesirable hot and cold spots within food being cooked. The aforementioned waveguide modulator technology (circular polarized microwave mode stirrers) to provide circularly polarized microwave ( ) energy dramatically improves the time averaged spatial distribution of energy. The spatial distribution is partially a function of reflections of microwave energy off the conductive cavity walls, thereby producing complex configurations of electromagnetic fields commonly referred to as modes. Simply stated, a major reason for the non-uniformity of the spatial distribution of microwave energy is the constructive and destructive interference of reflections. The waveguide modulator technology (circulator polarized microwave mode stirrers) help to overcome this issue hence improve the product quality.

By using a lower frequency industrial microwave the present invention results in a much reduced moisture content. Lower moisture lends itself to a longer shelf life and more stable product. This is necessary for a vending compatible product with a minimum six month shelf life.

Preferably a microwave with “Side Shielding” technology is used to stop what is known as the “End Effect”. With normal conveyor microwave technology in the active zone of the microwave oven/dryer, the product at the side of the conveyor is bombarded by microwave energy from the sides in addition to, the top. The product in the middle only has microwave energy from on top. This results in the potential for overly hot spots at the side extremities of the belt and hence lack of consistency, reduced quality consistency and wastages. To overcome this we use Side Shielding to deflect direct microwave energy Sideways.

TABLE 1
Compositional analysis of high protein, low fat snack product

| | | 915 | KitchenSamples |
|---|---|---|---|
| Test (Unit) | 915 MHz-Ferrite | MHz-IMS | 2045 MHz |
| Protein (g/100 g) | 38.6 | 38.2 | 36.8 |
| Moisture (g/100 g) | 5.5 | 3.5 | 13.9 |
| Ash (g/100 g) | 8.8 | 8.4 | 8.5 |
| CHO (g/100 g) | 47.1 | 49.9 | 40.9 |
| Kcal (per 100 g) | 343 | 353 | 310.5 |
| KJoules (per 100 g) | 1434 | 1474 | 1299 |
| Sodium (g/100 g) | 1.7 | 1.8 | 1.7 |
| Salt Equiv (g/100 g) | 4.3 | 4.6 | 4.2 |

The above table illustrates the comparison between lab-based ‘kitchen’ samples at 2450 MHz and samples produced in two different industrial microwaves, ‘Ferrite’ and ‘IMS’, both at 915 MHz. The main difference in terms of composition between the kitchen microwave and the 915 MHz microwaves was the drastically reduced moisture content in the 915 MHz microwaves. This leads to a crisper and more shelf-stable product.

### DETAILED DESCRIPTION OF THE INVENTION

### EXAMPLES

High Protein, Low Fat Snack Product Manufacturing Process

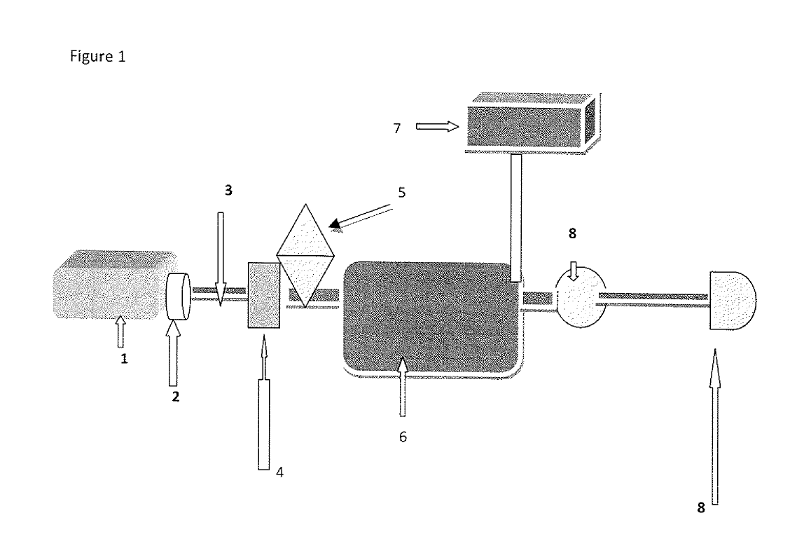

A schematic of the process of the invention is shown in FIG. 1. The ingredients are loaded into a mixer cooker (1) which has a forming or ejection head (2). Following mixing and cooking the ingredients are passed along a continuous, low dielectric belt (3) having indentations and shaping dyes. The mix is then passed to a rapid chiller (4) and following chilling the pieces are coated with oil by an oil spray atomiser (5). The pieces are then passed into a microwave oven (6) with the power of about 1100-800 MHz. The production line includes a 200-100 kW generator (7) and there may be one or a number of such generators.

There is a flavour duster/tumbler (8) which is used to coat the cooked pieces with flavour dust. This unit may additionally comprise an oil atomiser. The flavoured pieces may then be passed to a continuous weighing and packaging system (9).

The snack product is a blend of some or all of the ingredients listed in Table 2.

TABLE 2
Ingredient ranges for the high protein, low fat snack product

| Ingredient | Range (%) |
|---|---|
| Water | 40-65% |
| Protein (rennet& acid casein, whey, soya, | 10-38% |
| rice protein, pea protein) | |
| Starch (maize starch, rice starch, corn starch, | 5-30% |
| potato starch & tapioca starches) | |
| Flaxseed | 0-15% |
| Fat (rapeseed oil, sunflower oil) | 0-10% |
| Sodium chloride | 1-5% |
| Trisodium citrate | 0.5-5% |
| Disodium phosphate | 0.2-3% |
| Citric acid | 0.2-3% |
| Sorbic acid | 0.1-3% |

The ingredients were mixed using heat and shear to form a molten “mozzarella-like” mass before chilling into a solid structure for microwave expansion.

Blending and cooking of the raw ingredients was done using a twin-shaft solid flight agitator Blentech DM-10028x mixer (Blentech Corp., Santa Rosa, Calif., USA). The cooker is fitted with two augers, which provide a shearing kneading action along with steam-heated jacket and direct steam inlet valves for temperature control.

Table a1, a2, a3 and a4 list combinations of ingredients used in the manufacture of different samples of the high protein snack.

TABLE a1

| Ingredient | % by weight |
|---|---|
| Water | 60 |
| Rennet Casein | 20 |
| Maize starch | 17 |
| NaCl | 1.20 |
| Trisodium Citrate | 0.80 |
| Citric Acid | 0.50 |
| Disodium Phosphate | 0.40 |
| Sorbic Acid | 0.10 |
| Total | 100% |

TABLE a2

| Ingredient | % by weight |
|---|---|
| Water | 55 |
| Pea Protein | 20 |
| Flaxseed | 12 |
| Corn starch | 10 |
| NaCl | 1.20 |
| Trisodium Citrate | 0.80 |
| Citric Acid | 0.50 |
| Disodium Phosphate | 0.40 |
| Sorbic Acid | 0.10 |
| Total | 100% |

TABLE a3

| Ingredient | % by weight |
|---|---|
| Water | 60 |
| Soy Protein | 30 |
| Rice starch | 7 |
| NaCl | 1.20 |
| Trisodium Citrate | 0.80 |
| Citric Acid | 0.50 |
| Disodium Phosphate | 0.40 |
| Sorbic Acid | 0.10 |
| Total | 100% |

TABLE a4

| Ingredient | % by weight |
|---|---|
| Water | 55 |
| Rennet Casein | 20 |
| Maize starch | 18 |
| Rapeseed oil | 4 |
| NaCl | 1.20 |
| Trisodium Citrate | 0.80 |
| Citric Acid | 0.50 |
| Disodium Phosphate | 0.40 |
| Sorbic Acid | 0.10 |
| Total | 100% |

The ingredients were accurately weighed out into separate containers before mixing. First the water (and fat if used) was mixed with sodium chloride, trisodium citrate, disodium phosphate and sorbic acid at 50° C. and mixed for 2 minutes. Next, the protein was added and this was mixed for a further 2 minutes at 50° C. At this point, the temperature of the steam jacket on the mixer was increased to 80° C., which took another 2-3 minutes.

Once the temperature of the jacket reached 80° C., the starch was added to the mix. The product was mixed and visually assessed to make sure all moisture has been absorbed and that a homogeneous mixture had been formed. When all the free water was absorbed the citric acid was added and mixed for one final minute at 80° C.

During the mixing process, the agitators were operated at a speed of 80 rpm and they were also run in both forward and reverse motions to ensure the best possible mixing and blending of the ingredients.

After the cooking process, the mixture was discharged from the mixer at 80° C. into buckets, which were then sealed and chilled until the temperature of the product reached ≦5° C.

Industrial Microwave Expansion

The product was kept chilled until minutes before expansion to prevent it from drying out. The microwave used was a 915 MHz production-scale microwave, with a 90 kW magnetron (Ferrite Inc., Nashu, N.H., USA—and—Industrial Microwave Systems ltd., 10 Cannons Rd, Old Wolverton, Milton Keynes, UK—and—Industrial Microwave Systems., L.L.C. North Carolina, USA). Slices of the mix, approximately 10 mm thick were cut, and then diced into small pierced, each weighing ˜2 g.

The diced product was placed in PTFE (Teflon®) moulds and also on the PTFE sheet top of the conveyor to prevent the product from sticking to the conveyor belt (triple A smooth PEFT conveyors, mesh PTFE conveyors and dimpled PTFE conveyor belts) when heated. Other low dielectric materials were also trialled inc Kevlar. Coating the raw mix pieces in natural food grade vegetable oils prior to microwaving allows control of the expansion resulting in a flatter, less expanded crisp. A number of different power level and belt speeds (and hence, residence time) variations were tried in order to find the optimum combination for the product. The combination which gave the best results was 22 kW power and a belt speed of 12 feet/minute, giving a residence time under exposure to microwave heating approximately 20 seconds. The expansion and crunchiness (as measured by the maximum force (N) required to break the product heated in both the industrial microwave (Ferrite) and kitchen microwave) results obtained from a 915 MHz microwave were superior to those obtained from a 2040 MHz. This is a novel and unique way of expanding high protein crisps.

Conventional Microwave Expansion

The product was again kept in a chilled state until it was expanded to prevent it from drying out. The microwave used was a Whirlpool MW201 with a 1 kW magnetron, operating at a frequency of 2450 MHZ (FIG. 20). Slices of the mix, approximately 10 mm thick were cut, and then diced into small pieces, each weighing ˜2 g.

The diced samples were placed on a plate on top of a cling-film covering, to prevent sticking, and heated, three at a time in the microwave oven. Again samples were heated for different times to ascertain which gave the best final product. The best results were achieved with a heating time of 90 seconds.

Textural Analysis

Texture of the microwave-expanded product were analysed using a TA-XT 2i (Stable Microwave Systems, Godalming, Surrey, UK). The test used was a puncture test whereby the top shell of the product was broken by a probe, with the maximum force required to do so calculated. The calculations for maximum force were done using TE-UK software.

The puncture test was run using a 5 kg capacity load cell. The samples were placed, one at a time, on a flat steel plate and the probe was brought down so it was almost touching the top of the product. The 4 mm diameter probe then extended for 5 mm, into the product at a rate of 60 mm/minute.

TABLE 3
Maximum force (N) required to break the product heated in both the
industrial microwave (Ferrite) and the kitchen microwave

| | FERRITE | Kitchen Microwave |
|---|---|---|
| SAMPLE | (915 MHz) | (2450 MHz) |
| 1 | 6.741 | 1.669 |
| 2 | 4.566 | 1.832 |
| 3 | 4.845 | 1.817 |
| 4 | 5.714 | 2.187 |
| 5 | 3.480 | 3.394 |
| 6 | 3.294 | 2.634 |
| 7 | 4.614 | 1.947 |
| 8 | 7.393 | 2.222 |
| 9 | 3.716 | 1.137 |
| 10 | 4.977 | 1.655 |
| 11 | 4.184 | 1.497 |
| 12 | 4.015 | 1.265 |
| 13 | 7.481 | 1.919 |
| 14 | 5.625 | 2.155 |
| 15 | 6.557 | 1.867 |
| Average | 5.146 | 1.946 |
| Standard Deviation | 1.384 | 0.552 |

### Example 1

A snack food product mix comprising a standard recipe of approximately 20% by weight of protein, approximately 17% by weight of a starch, approximately 60% water, the remainder of the volume comprising emulsifiers, preservatives and flavourings, was prepared for processing.

The mix was mixed and cooked in a Blentech mixer cooker model no CC-0500 (Blentech Corp., Santa Rosa, Calif., USA). It was extruded hot (80+/−15° C.). and ejected in 0.02 gram to 5 gram pieces The pieces were shaped via a moving low dielectric moving belt and mould shapes and dyes. The belt and mould shapes/dyes were made from PTFE (Teflon). This is to prevent the product from sticking to the conveyor belt (triple A smooth PEFT conveyors, mesh PTFE conveyors and dimpled PTFE conveyor belts). Other low dielectric materials which would be suitable Kevlar. The shaped pieces were rapidly cooled to below 10° C. crust temperature on a continuous production line.

Surface coating of the unexpanded product pieces was performed prior to microwaving with food grade vegetable oils. This innovative step controls the expansion and shape of the finished product. If unexpanded (i.e. not micro-waved) product mix pieces were either surface immersed in natural food grade vegetable and/or were sprayed (atomized) with natural food grade vegetable oils prior to microwaving, the result was a flatter, less expanded crisp. The rate of expansion plus the shape of the final product could be manipulated and predetermined using this method. This final product shape could be further refined via filling unexpanded product into moulds and dyes made from low dielectric materials.

The pieces were then passed through an industrial microwave 915 MHz (Range 800-1100 MHz) frequency and a power of 75 KW (range 100 kW −20 kW), using single or multiple sets of Generators and Microwave chambers depending on the required capacity. Preferred additional technology is Low Frequency high powered Microwave technology with circularly polarizing waveguide modulators and side shielding technologies. A 915 MHz production-scale microwave, with a 90 kW magnetron is suitable, (Ferrite Inc., Nashu, N.H., USA).

Optionally an oil spray with natural food grade vegetable oils and additional flavourings may be used. The oil will act to affix pre-dust flavours and seasonings in addition to acting as a carrier of the flavour volatiles.

The final product is then passed to an automatic weighing and packaging station. This process involves using Microwave technology for expansion and drying, surface oil atomisation and immersion to control final product shape, rapid cooling to facilitate automation of the line whilst still permitting expansion and drying. It has been shown that neither effective drying nor expansion will occur unless the product is sufficiently chilled prior to micro waving. It was believed that the Starch in the raw mix would need 24 hours to set as an essential prerequisite step, prior to microwaving and to allow expansion and drying i.e. the starch matrix or cross bonds would need time to form. We have proven that this is not the case. The critical or determining factor is the initial temperature of the raw mix prior to microwaving it.

### CONCLUSION

The expansion and crunchiness, as measured by the maximum force (N) required to break the product heated in an industrial microwave (Ferrite) complete with a Ferrite polarizer and operating at 915 MHz microwave frequency were superior to those obtained from a regular, 2450 MHz kitchen microwave. The ingredient mix, manipulation of these ingredients and process are unique and a novel way of producing high protein crisps.

The words “comprises/comprising” and the words “having/including” when used herein with reference to the present invention are used to specify the presence of stated features, integers, steps or components but does not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

1. A method of making an expanded high protein snack product comprising:
(A) Mixing together water, protein and emulsifying salts in a pre-heated mixer at about 50 degrees centigrade;
(B) Heating the mixture to about 80 degrees centigrade and adding starch;
(C) Mixing until all free water is absorbed;
(D) Adding a preservative;
(E) Chilling the mixture and cutting it into pieces;
(F) Expanding the mixture by heating in a microwave at 800-1100 MHz frequency and a power of 10-75 kW,
wherein the cut pieces of step (E) are coated in vegetable oil.

2. A method as claimed in claim 1 wherein the microwave includes a magnetron.

3. A method as claimed in claim 2 wherein the microwave used is a 915 MHz microwave with a 90 KW magnetron.

4. A method as claimed in claim 1 wherein the heating time for expansion in step (F) is between 10 and 360 seconds.

5. A method as claimed in claim 4 wherein the heating time is 20 seconds.

6. A method as claimed in claim 1 wherein the protein is selected from the group consisting of rennet casein, acid casein, whey milk proteins, soya, tofu, (soya curd), rice protein, pea protein, flax seed proteins and protein isolates, linseed protein concentrate or legume protein isolates, or combinations thereof.

7. A method as claimed in claim 1 wherein the starch is selected from the group consisting of maize derived starch including pre-biotic, high amylase starch, Hi-Maize 260™, other corn starches, rice starch, flax starch, tapioca starch or potato starch.

8. A method as claimed in claim 1 wherein the ingredient mixture is 18-38% by weight of protein, 5-30% by weight of a maize derived starch, 40-65% water.

9. A method as claimed in claim 1 wherein the protein is mixed with emulsifying salts prior to addition of the starch.

10. A method as claimed in claim 1 wherein the mixture is cut into bite size pieces.

11. A method as claimed in claim 1 wherein additional ingredients selected from salt, tri sodium citrate, citric acid, disodium phosphate and sorbic acid are added to the mixture in step (A).

12. A method as claimed in claim 1 wherein vegetable oil is added in step (A).

13. A method of making an expanded high protein snack product substantially as described herein with reference to the Examples.

14. A snack food product whenever prepared by a method as claimed in claim 1.

15. A method of making an expanded high protein snack product comprising:
(A) mixing together water, protein, and emulsifying salts in a pre-heated mixer at about 50 degrees centigrade, the mixture being 40-65% by weight water and 18-38% by weight of protein;
(B) heating the mixture to about 80 degrees centigrade and adding starch, the mixture being 5-30% starch;
(C) mixing until all free water is absorbed;
(D) adding a preservative;
(E) chilling the mixture to a temperature of about 10 degrees centigrade or below and cutting the mixture into pieces;
(F) coating the pieces with a food-grade vegetable oil; and
(G) expanding the pieces of mixture by heating the pieces for a period of between 10-160 seconds in a microwave at frequency of 800-1100 MHz and a power of 10-75 kW.

16. The method of claim 15, wherein the microwave includes a 90-KW magnetron.

17. The method of claim 16, wherein the microwave is operable at a frequency of 915 MHz.

18. The method of claim 16, wherein
the protein is selected from the group consisting of rennet casein, acid casein, whey milk proteins, soya, tofu, rice protein, flax seed proteins and protein isolates, linseed protein concentrate, legume protein isolates, and combinations thereof; and
the starch is selected from the group consisting of maize-derived starch, pre-biotic and high-amylase starch, Hi-Maize 260™, other corn starches, rice starch, flax starch, tapioca starch, and potato starch.

19. The method of claim 18, wherein additional ingredients are added to the mixture in step (A), the additional ingredients being selected from the group consisting of salt, trisodium citrate, disodium phosphate, and sorbic acid
